(19) United States
(12) Patent Application Publication
(10) Pub. No.: US 2026/0059242 A1
(43) Pub. Date: Feb. 26, 2026

(54) DISPLAY APPARTUS

(71) Applicant: SAMSUNG ELECTRONICS CO., LTD., Suwon-si (KR)

(72) Inventors: Mingyu YOON, Suwon-si (KR); Kwangbok PARK, Suwon-si (KR); Seongsu PARK, Suwon-si (KR)

(73) Assignee: SAMSUNG ELECTRONICS CO., LTD., Suwon-si (KR)

(21) Appl. No.: 19/327,583

(22) Filed: Sep. 12, 2025

Related U.S. Application Data
(63) Continuation of application No. PCT/KR2025/011541, filed on Aug. 1, 2025.

(30) Foreign Application Priority Data
Aug. 20, 2024 (KR) 10-2024-0111610
Jan. 6, 2025 (KR) 10-2025-0001780

(51) Int. Cl. H04R 7/18; G06F 1/16; H04R 1/28; H04R 7/14; H04R 9/02; H04R 9/04; H04R 9/06

(52) U.S. Cl. CPC H04R 7/18; G06F 1/1605; H04R 1/2834; H04R 7/14; H04R 9/025; H04R 9/045; H04R 9/06; H04R 2400/11; H04R 2499/15

(57) ABSTRACT

A display apparatus according to an embodiment of the present disclosure includes a display panel having a front surface and a rear surface, a rear cover having a front side, a rear side, and an opening extending between the front side and the rear side, wherein the front side faces the rear surface of the display panel so that the rear cover covers the rear surface of the display panel, and a speaker between the rear surface of the display panel and the front side of the rear cover, the speaker including a diaphragm exposed to outside of the display apparatus through the opening of the rear cover, the diaphragm configured to vibrate and having a through-hole formed in the center of the diaphragm, and a fixing plate in the through-hole of the diaphragm and fixed in position so as not to vibrate together with the diaphragm.

### CROSS-REFERENCE TO RELATED APPLICATION

This application is a continuation application is a continuation application, under 35 U.S.C. § 111(a), of international application No. PCT/KR2025/011541, filed Aug. 1, 2025, which claims priority under 35 U. S. C. § 119 to Korean Patent Application No. 10-2024-0111610, filed Aug. 20, 2024, and Korean Patent Application No. 10-2025-0001780, filed Jan. 6, 2025, the disclosures of which are incorporated herein by reference in their entireties.

### TECHNICAL FIELD

The disclosure relates to a display apparatus including a speaker.

### BACKGROUND ART

In general, a display apparatus is a type of output device that converts acquired or stored electrical information into visual information and displays such information to a user.

The display apparatus may include a speaker for outputting sound information. The speakers are typically disposed on a rear surface or a side surface of the display apparatus, and such speakers may be a factor that increases the thickness of the display apparatus.

The thickness of display apparatus is trending toward thinner and thinner, and it is necessary to reduce the thickness of the speaker to reduce the overall thickness of the display apparatus. However, when the thickness of the speaker is reduced, it may be difficult to secure enough space for the speaker to be driven, which may lead to a decrease in sound performance.

Accordingly, various attempts have been made for a speaker capable of providing excellent sound performance while reducing thickness, and a display apparatus including the same.

### DISCLOSURE

### Technical Problem

An embodiment of the present disclosure provides a speaker capable of providing excellent sound performance while reducing thickness, and a display apparatus including the same.

An embodiment of the present disclosure provides a speaker in which a diaphragm is divided into a central portion and an outer portion, the central portion has a fixed position, and only the outer portion vibrates, thereby securing additional internal space, and a display apparatus including the same.

Technical tasks to be achieved in this document are not limited to the technical tasks mentioned above, and other technical tasks not mentioned will be clearly understood by those skilled in the art from the description below.

### Technical Solution

A display apparatus according to an embodiment of the present disclosure includes a display panel having a front surface and a rear surface, a rear cover having a front side, a rear side, and an opening extending between the front side and the rear side, wherein the front side faces the rear surface of the display panel so that the rear cover covers the rear surface of the display panel, and a speaker between the rear surface of the display panel and the front side of the rear cover, the speaker including a diaphragm exposed to outside the display apparatus through the opening of the rear cover, the diaphragm configured to vibrate and having a through-hole formed in the center of the diaphragm, and a fixing plate in the through-hole of the diaphragm and fixed in position so as not to vibrate together with the diaphragm.

### DESCRIPTION OF DRAWINGS

FIG. 1 illustrates a display apparatus according to an embodiment.

FIG. 2 is an exploded view illustrating the display apparatus according to an embodiment.

FIG. 3 illustrates a cross-section of a display panel in the display apparatus according to an embodiment.

FIG. 4 illustrates a rear view of the display apparatus according to an embodiment.

FIG. 5 illustrates a state in which a rear cover is removed from the display apparatus of FIG. 4.

FIG. 6 is a perspective view of a speaker device in the display apparatus according to an embodiment.

FIG. 7 is an exploded view of the speaker device shown in FIG. 6.

FIG. 8 illustrates a speaker in a display apparatus according to an embodiment.

FIG. 9 is an exploded view of the speaker shown in FIG. 8.

FIG. 10 illustrates FIG. 9 from another angle.

FIG. 11 illustrates a cross-section taken along line A-A′ of FIG. 8.

FIG. 12 illustrates a speaker in a display apparatus according to an embodiment.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

In addition, the terms ‘portion’, ‘part’, ‘module’ and ‘member’ may be implemented in hardware or software. Depending on the embodiments, a plurality of ‘portions’, ‘parts’, ‘modules’, and ‘members’ may be implemented as a single element, or a single ‘portions, ‘part’, ‘module’, or ‘member’ may include a plurality of elements.

Also, the terms used herein are used to describe the embodiments and are not intended to limit and/or restrict the disclosure. The singular forms “a”, “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

When an element (e.g., a first element) is referred to as being “(functionally or communicatively) coupled” or “connected” to another element (e.g., a second element), the first element may be connected to the second element, directly (e.g., wired), wirelessly, or through a third element.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

The terms “up,” “down,” “front,” “rear,” and the like used in the following description may be defined with reference to the drawings, and the shape and position of each element are not limited by these terms. For example, the terms “front” and “rear” below may each be defined with reference to an +X direction and −X direction shown in the drawings, respectively. The terms “up” and “down” below may each be defined with reference to a +Z direction and −Z direction shown in the drawings. The terms “left” and “right” below may each be defined with reference to a +Y direction and −Y direction shown in the drawings. The terms “vertical direction” below may be defined with reference to the Z direction shown in the drawings, and the terms “horizontal direction” below may be defined with reference to the Y direction shown in the drawings.

Hereinafter, various embodiments of the disclosure will be described in detail with reference to the accompanying drawings.

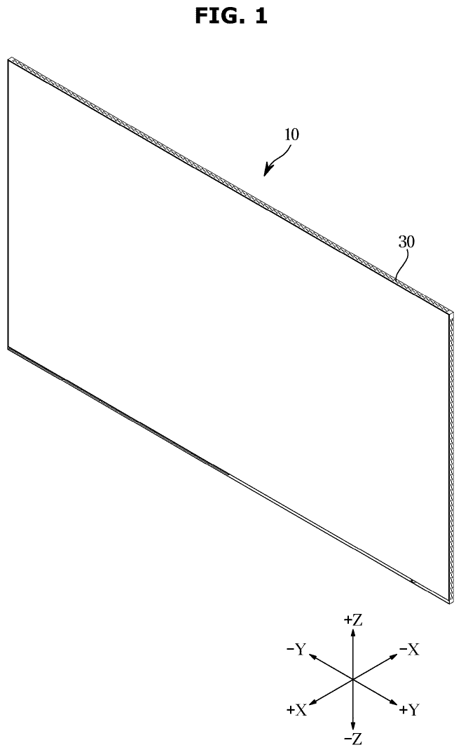

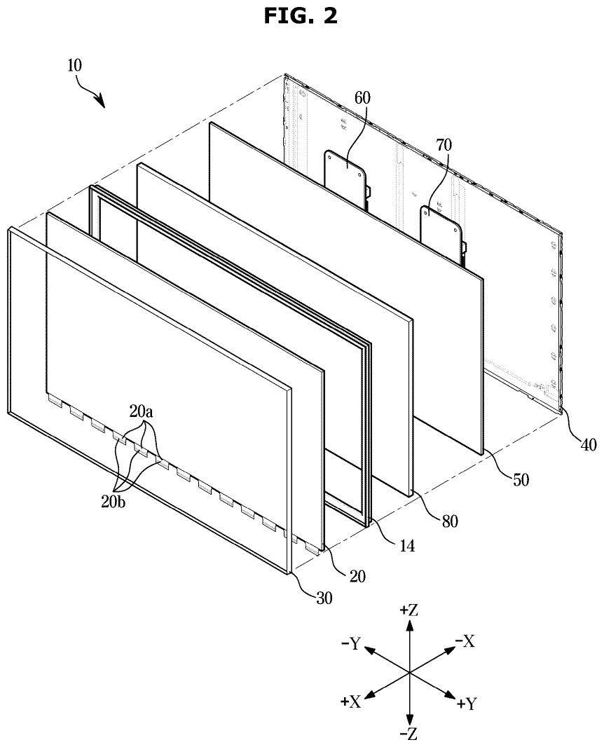

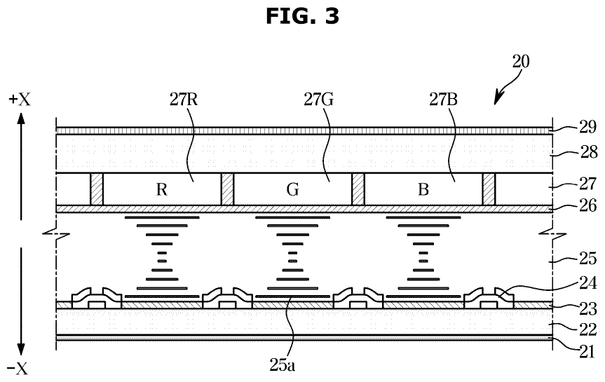

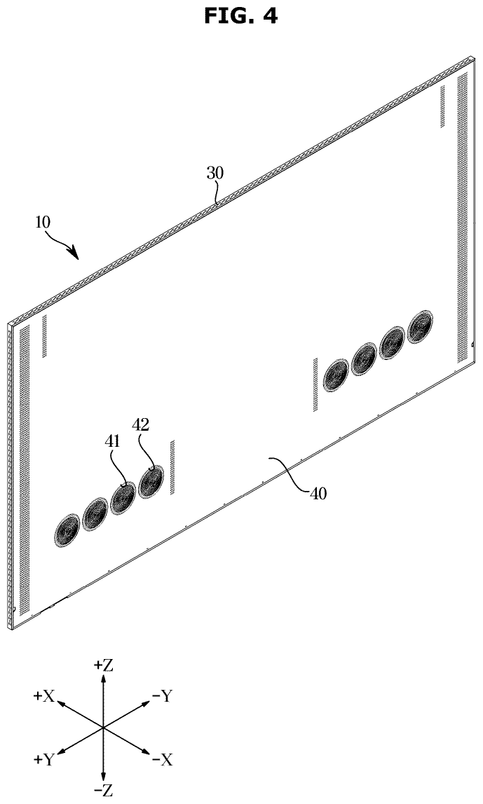

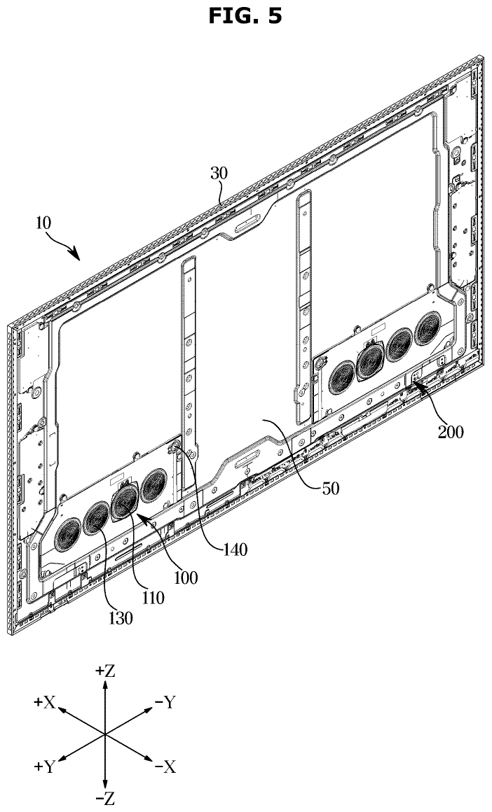

FIG. 1 is a view illustrating a display apparatus according to an embodiment. FIG. 2 is an exploded view illustrating the display apparatus according to an embodiment. FIG. 3 is a cross-sectional view illustrating a display panel in the display apparatus according to an embodiment. FIG. 4 is a rear view of the display apparatus according to an embodiment. FIG. 5 illustrates a state in which a rear cover is removed from the display apparatus of FIG. 4.

Referring to FIG. 1, a display apparatus 10 may be an apparatus capable of processing image signals received from an external source and visually displaying the processed image. In the following, a case where the display apparatus 10 is a television (TV) is exemplified, but the present disclosure is not limited thereto. For example, the display apparatus 10 may be implemented in various forms, such as a monitor, a portable multimedia device, a portable communication device, or the like, and the display apparatus 10 is not limited to any form as long as it is an apparatus that visually displays images.

The display apparatus 10 may receive content data including video data and audio data from various content sources, and output video and audio corresponding to the video data and audio data. For example, the display apparatus 10 may receive content data via a broadcast receiving antenna or a wired cable, receive content data from a content playback device, or receive content data from a content delivery server of a content provider.

Referring to FIG. 2, the display apparatus 10 according to an embodiment may include a light source device 80 that is a surface light source, a display panel 20 that blocks or passes light emitted from the light source device 80, a front chassis 30 and a frame middle mold 14 configured to cover at least a portion of a side surface and a front surface of the display panel 20, a rear chassis 50 configured to cover the rear surface of the display panel 20, a rear cover 40 configured to cover a rear surface of the rear chassis 50, and a speaker device 100. In addition, the display apparatus 10 may be provided with a control assembly 70 that controls operations of the light source device 80 and the display panel 20, and a power assembly 60 that supplies power to the light source device 80 and the display panel 20.

The light source device 80 may include a point light source that emits monochromatic light or white light, and may refract, reflect, and scatter light to convert the light emitted from the point light source into uniform surface light. For example, the light source device 80 may include a plurality of light sources that emit monochromatic light or white light, a diffuser plate that diffuses light incident from the plurality of light sources, a reflective sheet that reflects light emitted from a rear surface of the plurality of light sources and the diffuser plate, and an optical sheet that refracts and scatters light emitted from a front surface of the diffuser plate.

As such, the light source device 80 may emit uniform planar light toward a front by refracting, reflecting, and scattering the light emitted from the light source.

According to an embodiment, the display apparatus 10 may include a non-emissive panel. For example, the display apparatus 10 may include the display panel 20 and the backlight unit configured to provide light to the display panel 20. For example, the display panel 20 may be a display panel. The display panel may be configured to block or transmit light from the backlight unit. The backlight unit may be disposed at a rear side of the display panel and configured to provide light to the display panel. The display panel may receive light from the backlight unit to form a screen of the display apparatus. For example, the display apparatus 10 may include a backlight unit, a quantum dot layer, a display panel, and a color filter.

According to an embodiment, the display apparatus 10 may include a self-emissive panel. In this case, the display panel 20 may be configured to emit light up on its own, and may not include a backlight unit to provide light to the display panel 20. For example, the display panel 20 may be an organic light emitting diode (OLED) panel. For example, the display panel 20 may be a Micro LED panel in which light emitting diodes have a size of less than 100 micrometers (μm).

The front chassis 30 may be configured to cover a side surface of the display panel 20. The front chassis 30 may be configured to cover at least a portion of a front surface of the display panel 20. Specifically, the front chassis 30 may be configured to cover a border of the front surface of the display panel 20. A front portion of the front chassis 30 exposed on the front surface of the display apparatus 10 may be referred to as a bezel.

The front chassis 30 may be formed to extend along a perimeter of the display panel 20. The front chassis 30 may be arranged in an approximately rectangular loop shape. The front chassis 30 may protect the display panel 20 and form a side exterior of the display apparatus 10 by covering at least a portion of the side surfaces and the front surface of the display panel 20. In addition, the front chassis 30 may form a portion of a front exterior of the display apparatus 10.

Referring to FIG. 5, the display apparatus 10 may include the rear chassis 50. The rear chassis 50 may be disposed on a rear side of the display panel 20. In cases where the display apparatus 10 includes a backlight unit, the rear chassis 50 may support the backlight unit. In cases where the display apparatus 10 does not include a backlight unit, the rear chassis 50 may support the display panel 20. In addition, the rear chassis 50 may support various components of the display apparatus 10, such as a control assembly, a power assembly, and the like.

The rear chassis 50 may be formed to have an approximately flat plate shape, but is not limited thereto. The rear chassis 50 may be configured to include a material having high thermal conductivity to facilitate heat dissipation to an outside. In an example, the rear chassis 50 may be configured to include a metallic material, such as aluminum or steel use stainless (SUS), or a plastic material, such as acrylonitrile butadiene styrene (ABS).

Referring to FIG. 4, the rear cover 40 may be configured to cover the rear surface of the display panel 20. The rear cover 40 may be disposed on the rear side of the display panel 20. The rear cover 40 may be provided with a size and shape corresponding to the display panel 20. The rear cover 40 may include a first opening 41. The first opening 41 may expose at least a portion of the speaker device 100 to a rear side of the rear cover 40. Specifically, a vibration plate (hereinafter referred to as a diaphragm) 111 and a fixing plate 112 of a speaker 110 of the speaker device 100 may be exposed to the rear side of the rear cover 40 through the first opening 41.

The rear cover 40 may further include a second opening 42. The second opening 42 may expose at least a portion of the speaker device 100 to the rear side of the rear cover 40. Specifically, a passive diaphragm 131 and a passive fixing plate 132 of a passive radiator 130 of the speaker device 100 may be exposed to the rear side of the rear cover 40 through the second opening 42.

Referring to FIGS. 4 and 5, the display apparatus 10 may include the speaker device 100 configured to output audio corresponding to audio data. The speaker device 100 may be disposed on the rear side of the display panel 20. The speaker device 100 may be disposed on a rear side of the rear chassis 50. The speaker device 100 may be disposed on a front side of the rear cover 40. The speaker device 100 may be disposed between the rear chassis 50 and the rear cover 40.

As described above, at least a portion of the speaker device 100 may be exposed to the rear surface of the display apparatus 10 through the first opening 41 and the second opening 42 of the rear cover 40. At least a portion of the speaker device 100 may pass through the first opening 41 and the second opening 42 and protrude to the rear side of the rear cover 40. At least a portion of the speaker device 100 may be inserted into the first opening 41 and the second opening 42. At least a portion of the speaker device 100 may protrude from an inner side of the rear cover 40 through the first opening 41 and the second opening 42 to an outer side of the rear cover 40.

The display apparatus 10 may include a first speaker device 100 disposed on one side of the rear chassis 50 and a second speaker device 200 disposed on the other side of the rear chassis 50. The first speaker device 100 and the second speaker device 200 may be arranged to have a symmetrical shape. For example, the first speaker device 100 and the second speaker device 200 may be symmetrical with respect to an imaginary line traversing a center of the display apparatus 10 in a vertical direction. Hereinafter, only the first speaker device 100 will be described to omit redundant descriptions. In addition, the first speaker device 100 may be referred to as the speaker device 100.

Referring to FIG. 3, an example of the display panel 20 will be described.

The display panel 20 may include a first polarizing film 21, a first transparent substrate 22, a pixel electrode 23, a thin film transistor (TFT) 24, a liquid crystal layer 25, a common electrode 26, a color filter 27, a second transparent substrate 28, and a second polarizing film 29.

The first transparent substrate 22 and the second transparent substrate 28 may fixedly support the pixel electrode 23, the TFT 24, the liquid crystal layer 25, the common electrode 26, and the color filter 27. The first and second transparent substrates 22 and 28 may be formed of tempered glass or transparent resin.

The first polarizing film 21 and the second polarizing film 29 may be arranged on outer sides of the first and second transparent substrates 22, 28, respectively.

The first polarizing film 21 and the second polarizing film 29 may each allow certain light to pass through and block other light. For example, the first polarizing film 21 may allow light having a magnetic field oscillating in a first direction to pass through and to block other light. In addition, the second polarizing film 29 may allow light having a magnetic field oscillating in a second direction to pass though and to block other light. At this time, the first direction and the second direction may be orthogonal to each other. Accordingly, a polarization direction of light passed by the first polarizing film 21 and an oscillation direction of light passed by the second polarizing film 29 may be orthogonal to each other. As a result, light generally cannot pass through both the first polarizing film 21 and the second polarizing film 29 simultaneously.

The color filter 27 may be arranged on an inner side of the second transparent substrate 28.

The color filter 27 may include, for example, a red filter 27R that passes red light, a green filter 27G that passes green light, and a blue filter 27G that passes blue light. The red filter 27R, the green filter 27G, and the blue filter 27B may be arranged next to each other. A region in which the color filter 27 is formed may correspond to a pixel of the display panel 20. A region in which the red filter 27R is formed may correspond to a red sub-pixel. A region in which the green filter 27G is formed may correspond to a green sub-pixel. A region in which the blue filter 27B is formed may correspond to a blue sub-pixel.

The pixel electrode 23 may be arranged on an inner side of the first transparent substrate 22, and the common electrode 26 may be arranged on the inner side of the second transparent substrate 28.

The pixel electrode 23 and the common electrode 26 may be made of an electrically conductive metal material and may generate an electric field to change an arrangement of liquid crystal molecules 25a constituting the liquid crystal layer 25, which will be described below.

The pixel electrode 23 and the common electrode 26 may be made of a transparent material and may transmit light incident from the outside. For example, the pixel electrode 23 and the common electrode 26 may be made of indium tin oxide (ITO), indium zinc oxide (IZO), Ag nano wire, carbon nano tube (CNT), graphene, or PEDOT (3,4-ethylenedioxythiophene), or the like. The TFT 24 may be arranged on the inner side of the first transparent substrate 22.

The TFT 24 may allow current flowing through the pixel electrode 23 to pass or be blocked. For example, depending on a turn-on (closed) or turn-off (open) state of the TFT 24, an electric field may be formed or removed between the pixel electrode 23 and the common electrode 26.

The TFT 24 may be made of poly-Silicon and may be formed using semiconductor processes, such as lithography, deposition, or ion implantation.

The liquid crystal layer 25 may be formed between the pixel electrode 23 and the common electrode 26. The liquid crystal layer 25 may be filled with liquid crystal molecules 25a.

A liquid crystal is a material that exhibits properties intermediate between a solid (crystal) and a liquid. Most liquid crystal materials may be organic compounds, and their molecular shape is a long and thin rod shape. The arrangement of molecules may be irregular in some directions, but may have a regular crystalline form in other directions. As a result, liquid crystal may have both the fluidity of a liquid and the optical anisotropy of a crystal (solid).

In addition, liquid crystal may exhibit optical properties in response to changes in the electric field. For example, the liquid crystal may change the orientation of the arrangement of molecules constituting the liquid crystal in response to changes in the electric field. When an electric field is generated in the liquid crystal layer 25, the liquid crystal molecules 25a of the liquid crystal layer 25 may be align according to a direction of the electric field, and when no electric field is generated in the liquid crystal layer 25, the liquid crystal molecules 25a may be arranged irregularly or along an alignment film (not shown). As a result, the optical properties of the liquid crystal layer 25 may vary depending on presence or absence of an electric field passing through the liquid crystal layer 25.

Referring to FIG. 2, on one side of the display panel 20, a cable 20a for transmitting image data to the display panel 20 and a display driver integrated circuit (DDI) 20b (hereinafter referred to as a ‘driver IC’) for processing digital image data and outputting analog image signals may be provided.

The cable 20a may electrically connect the control assembly 70 and/or the power assembly 60 to the driver IC 20b, and also electrically connect the driver IC 20b to the display panel 20. The cable 20a may include a flexible flat cable or a film cable that may be bent.

The driver IC 20b may receive image data and power from the control assembly 70 and/or the power assembly 60 through the cable 20a, and transmit image data and drive current to the display panel 20 through the cable 20a.

In addition, the cable 20a and the driver IC 20b may be integrally implemented as a film cable, a chip on film (COF), a tape carrier packet (TCP), or the like. In other words, the driver IC 20b may be disposed on the cable 20a. However, the present disclosure is not limited thereto, and the driver IC 20b may be disposed on the display panel 20.

The control assembly 70 may include a control circuitry that controls operations of the display panel 20 and the light source device 80. The control circuitry may process image data received from an external content source, transmit image data to the display panel 20, and transmit dimming data to the light source device 80.

The power assembly 60 may provide power to the display panel 20 and the light source device 80 such that the light source device 80 outputs surface light and the display panel 20 blocks or passes the light of the light source device 80.

The control assembly 70 and the power assembly 60 may be implemented as a printed circuit board and various circuitry mounted on the printed circuit board. For example, a power circuitry may include capacitors, coils, resistors, processors, and the like, and a power circuit board on which they are mounted. In addition, a control circuitry may include a memory, a processor, and a control circuit board on which they are mounted.

The structure of the display panel 20 described above with reference to FIG. 3 is merely an example of a structure that a display panel of a display apparatus according to the present disclosure may have, and the present disclosure is not limited thereto.

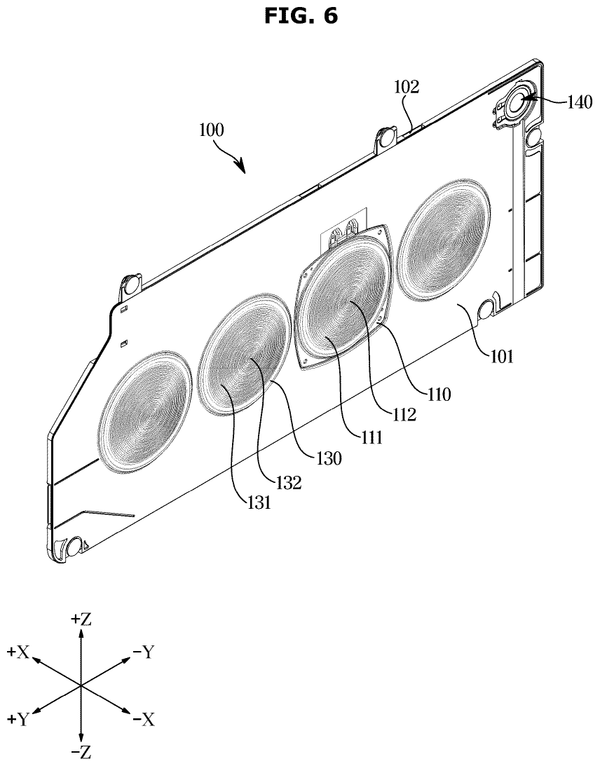

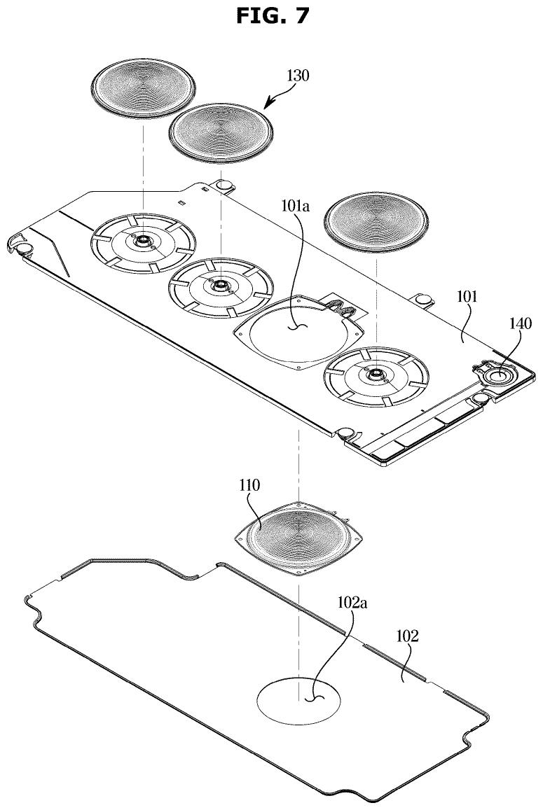

FIG. 6 is a perspective view of the speaker device in the display apparatus according to an embodiment. FIG. 7 is an exploded view of the speaker device shown in FIG. 6.

Referring to FIGS. 6 and 7, the speaker device 100 may include a first enclosure 101, a second enclosure 102 configured to be coupled to the first enclosure 101, and the speaker 110 arranged between the first enclosure 101 and the second enclosure 102. The speaker device 100 may further include the passive radiator 130 arranged on a side of the speaker 110. In addition, the speaker device 100 may further include a center speaker 140 disposed adjacent to a corner of the first enclosure 101 and the second enclosure 102.

The speaker device 100 may be coupled to the rear chassis 50 such that the first enclosure 101 faces the rear side of the display apparatus 10. The second enclosure 102 may be coupled to the rear chassis 50 such that the second enclosure 102 faces the front side of the display apparatus 10.

The first enclosure 101 and the second enclosure 102 may be coupled to each other. The first enclosure 101 and the second enclosure 102 may be coupled to each other to form a predetermined space therein. Sound pressure generated by the speaker 100 may be transmitted to the passive radiator 130 through the predetermined space formed between the first enclosure 101 and the second enclosure 102.

The first enclosure 101 may include a first enclosure opening 101a into which at least a portion of the speaker 110 is inserted and penetrated. The second enclosure 102 may include a second enclosure opening 102a into which at least a portion of the speaker 110 is inserted.

The first enclosure 101 may be mounted with the center speaker 140. The center speaker 140 may be configured to reinforce sound from a central portion side of the display apparatus 10. To this end, the center speaker 140 may be arranged as close as possible to the central portion of the display apparatus 10. Accordingly, the center speaker 140 of the first speaker device 100 may be disposed as biased as possible in the −Y direction and the +Z direction. The center speaker of the second speaker device 200 may be disposed as biased as possible in the +Y direction and the +Z direction.

The speaker 110 may be configured to convert electrical signals into sound. The speaker 110 may be configured to generate sound. The speaker 110 may receive electrical signals as input and move a diaphragm to generate sound. The speaker 110 may be an active configuration that generates sound by vibrating a diaphragm, and the passive radiator 130 may be a passive configuration that is passively vibrated by changes in air pressure inside the first enclosure 101 and the second enclosure 102 caused by drive of the speaker 110.

The first enclosure 101 may support one side of the speaker 110. The second enclosure 102 may support the other side of the speaker 110. At least a portion of the speaker 110 may be placed or accommodated between the first enclosure 101 and the second enclosure 102.

According to an embodiment, the passive radiator 130 may be coupled to the first enclosure 101. The passive radiator 130 may not include a voice coil and a magnet. The passive radiator 130 may include the passive diaphragm 131 and the passive fixing plate 132 inserted into a hole formed in a center of the diaphragm 131. The passive diaphragm 131 may vibrate as the air inside the first enclosure 101 and the second enclosure 102 is compressed and expanded due to operation of the speaker 110. The passive fixing plate 132 may be fixed in position regardless of the vibration of the passive diaphragm 131. In other words, the passive fixing plate 132 may not vibrate together with the passive diaphragm 131.

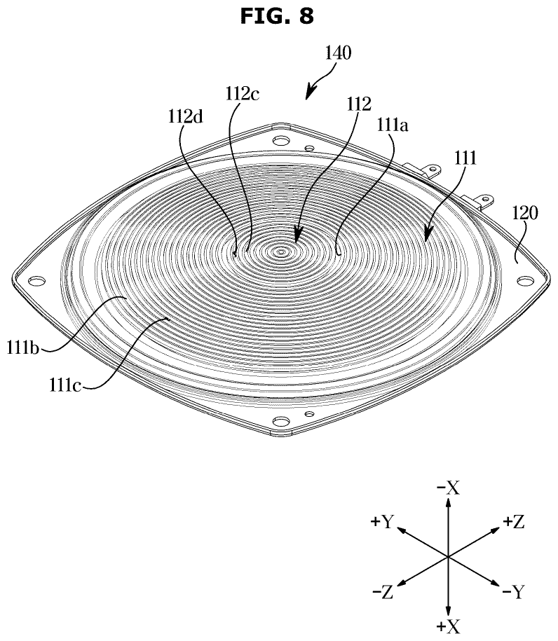

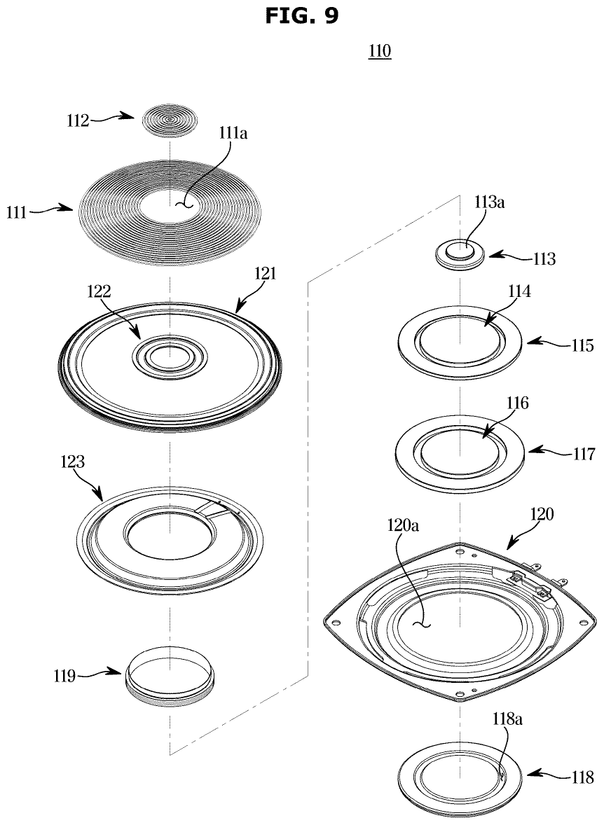

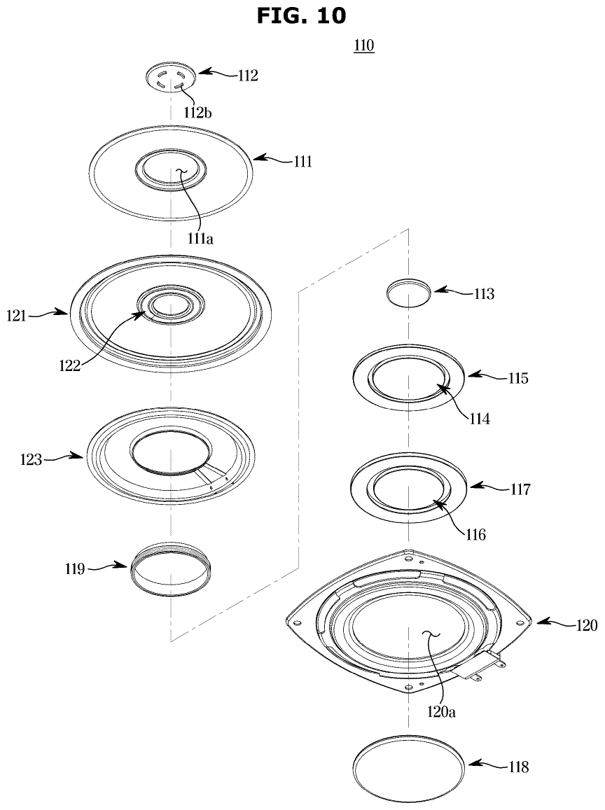

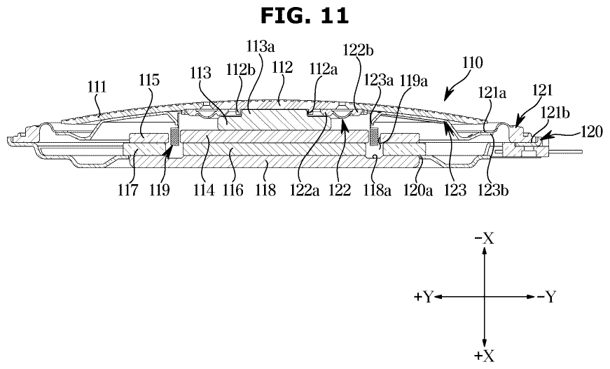

FIG. 8 illustrates a speaker in the display apparatus according to an embodiment. FIG. 9 is an exploded view of the speaker shown in FIG. 8. FIG. 10 illustrates FIG. 9 from another angle. FIG. 11 is a cross-section view taken along line A-A′ of FIG. 8.

In the following, the speaker 110 according to an embodiment will be described in detail with reference to FIGS. 8 to 11.

Referring to FIGS. 8 and 9, the speaker 110 may include the diaphragm 111 and the fixing plate 112 arranged in the center of the diaphragm 111. The diaphragm 111 may be exposed to the rear side of the rear cover 40 through the first opening 41 of the rear cover 40. The fixing plate 112 may be inserted into a through-hole 111a formed in the center of the diaphragm 111.

According to an embodiment, the diaphragm 111 and the fixing plate 112 may include a plurality of circular protrusions 111b and 112c and a plurality of circular grooves 111c and 112d having the same center and different diameters, respectively.

The center of the plurality of circular protrusions 112c of the fixing plate 112 may be the center of the fixing plate 112. The plurality of circular protrusions 112c of the fixing plate 112 may refer to circular protrusions that gradually increase in diameter from the center of the fixing plate 112. The plurality of circular grooves 112d of the fixing plate 112 may refer to a plurality of circular grooves formed between the plurality of circular protrusions 112c.

The center of the plurality of circular protrusions 111b of the diaphragm 111 may be the center of the fixing plate 112. The plurality of circular protrusions 111b of the diaphragm 111 may refer to circular protrusions that gradually increase in diameter from the through-hole 111a of the diaphragm 111. The plurality of circular grooves 111c of the diaphragm 111 may refer to a plurality of circular grooves formed between the plurality of circular protrusions 111b.

According to an embodiment, the diaphragm 111 and the fixing plate 112 may each include the plurality of circular protrusions 111b and 112c and the plurality of circular grooves 111c and 112d having the same center, so that the diaphragm 111 and the fixing plate 112 may appear to be not separated from each other in appearance. This may allow the diaphragm 111 and the fixing plate 112 to appear as a single configuration in terms of design. However, the present disclosure is not limited thereto. The diaphragm and the fixing plate may not include the plurality of circular protrusions and the plurality of circular grooves.

The diaphragm 111 and the fixing plate 112 may protrude to the rear side of the rear cover 40 through the first opening 41 of the rear cover 40. At least a portion of the diaphragm 111 and the fixing plate 112 may located on the outer side of the rear cover 40 on from an inner side of the rear cover 40 through the first opening 41.

Referring to FIGS. 9 to 11, the speaker 110 may include the diaphragm 111, the fixing plate 112 disposed at the center of the diaphragm 111, a magnet 116, a first plate 114 configured to cover a first surface of the magnet 116, a second plate 118 configured to cover a second surface of the magnet 116, and a support member 113 arranged between the first plate 114 and the fixing plate 112 so as to support the fixing plate 112.

The magnet 116 may be a permanent magnet. The magnet 116 may form a static magnetic field capable of interacting with a voice coil 119, which will be described later.

The first plate 114 may be attached to the magnet 116 to cover the first surface of the magnet 116. The first plate 114 may be arranged to have a shape corresponding to the magnet 116. The first plate 114 may increase the magnetic flux density to provide a stronger driving force to the voice coil 119. The first plate 114 may stably support the magnet 114. The first plate 114 may absorb and dissipate heat generated by the voice coil 119. In addition, by being made of a metallic material with high thermal conductivity, the first plate 114 may dissipate heat generated by the voice coil 119.

The second plate 118 may be attached to the magnet 116 to cover the second surface of the magnet 116. The second plate 118 may have an adhesive surface with a shape corresponding to the magnet 116. The magnet 116 may be coupled to the adhesive surface. The second plate 118, as the first plate 114, may the increase magnetic flux density to provide a stronger driving force to the voice coil 119. In addition, the second plate 118 may stably support the magnet 114. The second plate 118 may absorb and dissipate heat generated by the voice coil 119. In addition, by being made of a metallic material with high thermal conductivity, the second plate 118 may dissipate heat generated by the voice coil 119.

The support member 113 may be arranged between the fixing plate 112 and the first plate 114. The support member 113 may be arranged to be attached to the first plate 114. The fixing plate 112 may be arranged to be coupled to the support member 113. By coupling the fixing plate 112 to the support member 113, the position of the fixing plate 112 may be fixed. By fixing the position of the fixing plate 112, the fixing plate 112 may not vibrate together with the diaphragm 111 during vibration of the diaphragm 111. For example, the fixing plate 112 may have reduced vibration with respect to the diaphragm 111.

The support member 113 may include a guide portion 113a for guiding a coupling position of the fixing plate 112. The guide portion 113a may protrude toward the fixing plate 112. The guide portion 113a may be provided at a center of the support member 113.

The magnet 116, the first plate 114, the support member 113, and the second plate 118 described above may be coupled or attached to each other by an adhesive means such as an adhesive or double-sided tape. In addition, a ring magnet 117, a ring plate 115, and the second plate 118 may be coupled or attached by an adhesive means such as an adhesive or double-sided tape.

Referring to FIG. 11, the fixing plate 112 may include a guide groove 112a into which the guide portion 113a is inserted. The guide groove 112a may be formed in a shape corresponding to the guide portion 113a. In response to the insertion of the guide portion 113a into the guide groove 112a, the fixing plate 112 may be located at the center of the support member 113. Therefore, by providing the guide groove 112a and the guide portion 113a, the fixing plate 112 may be coupled at the center of the support member 113 without a separate jig or tool.

Referring to FIG. 10, the fixing plate 112 may include a guide protrusion 112b protruding from one surface of the fixing plate 112 toward the support member 113 so as to form the guide groove 112a. According to an embodiment, the guide portion 113a may be inserted inside the guide protrusion 112a, and a predetermined space formed inside the guide protrusion 112a may be the guide groove 112a described above. The guide protrusion 112a may include a plurality of guide protrusions 112a arranged to be spaced apart along a circumferential direction of the guide portion 113a. However, the present disclosure is not limited thereto. The fixing plate may not include the guide protrusion, and may include a guide groove formed by recessing at least a portion of one surface of the fixing plate. In addition, the fixing plate may include a guide rib in the shape of a cylinder instead of the plurality of guide protrusions.

Referring to FIGS. 9 and 10, the speaker 110 may include the ring magnet 117 having a ring shape, the ring plate 115 having a ring shape, and the voice coil 119.

The speaker 110 may further include the ring magnet 117 disposed on an outer edge of the disc-shaped magnet 116, thereby further increasing magnetic the flux density. The ring magnet 117 may increase energy efficiency by reducing unnecessary magnetic field leakage. The ring magnet 117 may make a magnetic circuit more efficient. By further including the ring magnet 117, the speaker 110 may provide more powerful and accurate driving force to the voice coil 119.

The speaker 110 may further include the ring plate 115 disposed on an outer edge of the disc-shaped first plate 114, thereby increasing the magnetic flux density to provide a stronger driving force to the voice coil 119. The ring plate 115 may be provided with a shape corresponding to the ring magnet 117. The ring plate 115, by being coupled to a first surface of the ring magnet 117, may stably support the ring magnet 117. The ring plate 115 may absorb and dissipate heat generated by the voice coil 119. In addition, the ring plate 115, by being made of a metallic material with high thermal conductivity, may dissipate heat generated by the voice coil 119.

According to an embodiment, the first plate 114, the ring plate 115, and the second plate 118 described above may be made of the same material. However, the present disclosure is not limited thereto. At least one of the first plate, the ring plate, or the second plate may be provided as a permanent magnet.

The voice coil 119 may be provided by winding a plurality of turns of copper wire around a cylindrical bobbin. When a voltage based on an audio signal is applied to the voice coil 119, current may flow through the voice coil 119 due to the voltage applied to the voice coil 119. As current flows through the voice coil 119, an electromagnetic field may be formed around the voice coil 119. The electromagnetic field formed around the voice coil 119 may interact with the static magnetic field of the magnet 116 and the ring magnet 117, and such interaction may cause the voice coil 119 to vibrate. The voice coil 119 may be connected to the diaphragm 111 to vibrate together with the diaphragm 111. As the voice coil 119 and the diaphragm 111 vibrate, the speaker 110 may output sound.

Referring to FIG. 11, the voice coil 119 may be disposed in a receiving space 119a formed between the magnet 116 and the first plate 114, and the ring magnet 117 and the ring plate 115. The second plate 118 may include a receiving groove 118a corresponding to the receiving space 119a to expand the receiving space 119a.

The voice coil 119 may vibrate in the forward (+X direction) and rearward (−X direction) within the receiving space 119a and the receiving groove 118a. The voice coil 119 may vibrate in a front-to-back direction within a range where it does not come into contact with the second plate 118. As the voice coil 119 vibrates, the diaphragm 111 may vibrate between a first position located rearward (−X direction) of the fixing plate 112 and a second position located forward (+X direction) of the fixing plate 112. As described above, the position of the fixing plate 112 may be fixed regardless of whether the diaphragm 111 vibrates.

According to the present disclosure, the speaker 110 may include a connector 123 connecting the voice coil 119 and the diaphragm 111 such that the diaphragm 111 vibrates together with the voice coil 119, and a frame 120 configured to support the ring magnet 117.

The connector 123 may be coupled to the diaphragm 111. With the diaphragm 111 being coupled to the connector 123 and the connector 123 being connected to the voice coil 119, the diaphragm 111 may vibrate together with the voice coil 119.

The frame 120 may include a frame hole 120a formed at a center thereof. The second plate 118 may be inserted into the frame hole 120a. The frame hole 120a may be provided with a shape and size corresponding to the second plate 118.

The speaker 110 may include a first edge 121 connecting an outer edge of the connector 123 and the frame 120 such that the frame 120 supports the connector 123. An inner edge of the connector 123 may be connected to the voice coil 119.

The speaker 110 may include a second edge 122 connecting an inner edge of the diaphragm 111 and the fixing plate 112 such that the fixing plate 112 supports the inner edge of the diaphragm 111. An inner edge of the second edge 122 may be connected to the fixing plate 111. An outer edge of the second edge 112 may be connected to the inner edge of the diaphragm 111. With such a structure, the inner edge of the diaphragm 111 may be supported by the fixing plate 111 through the second edge 122. An outer edge of the diaphragm 111 may be supported by the frame 120 through the first edge 121.

Referring to FIG. 11, one side 121a or an inner edge 121a of the first edge 121 may be connected, coupled, or attached to the other side 123b or an outer edge 123b of the connector 123. The other side 121b or an outer edge 121b of the first edge 121 may be connected, coupled, or attached to the frame 120.

One side 122a or an inner edge 122a of the second edge 122 may be connected, coupled, or attached to the fixing plate 111. The other side 122b or an outer edge 122b of the second edge 122 may be connected, coupled, or attached to the inner edge of the diaphragm 111.

One side 123a or an inner edge 123a of the connector 123 may be connected, coupled, or attached to the voice coil 119. Specifically, the one side 123a or the inner edge 123a of the connector 123 may be connected, coupled, or attached to the bobbin of the voice coil 119. The other side 123b or an outer edge 123b of the connector 123 may be connected, coupled, or attached to the one side 121a or the inner edge 121a of the first edge 121.

As described above, the speaker 110 according to the present disclosure may include the fixing plate 112 that is fixed in position at the center of the diaphragm 111 and is configured such that only the diaphragm 111 vibrates, thereby additionally securing a vibratable space inside the speaker 110. This may reduce a thickness of the speaker 110 and the display apparatus 10 including the same, while still providing excellent sound performance.

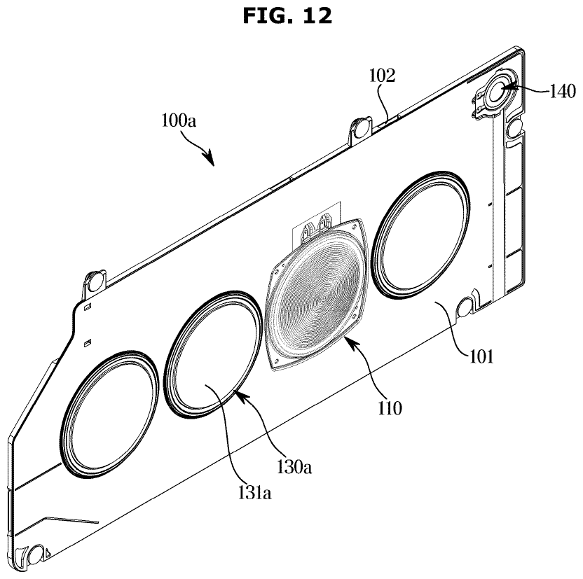

FIG. 12 is a view illustrating a speaker in a display apparatus according to an embodiment.

Referring to FIG. 12, a speaker device 100a according to an embodiment may include the first enclosure 101, the second enclosure 102, the center speaker 140, and the speaker 110. Since the first enclosure 101, the second enclosure 102, the center speaker 140, and the speaker 110 are the same as the configurations described in FIGS. 1 to 10, redundant descriptions will be omitted.

According to an embodiment, the speaker device 100a may include a passive radiator 130a. The passive radiator 130a may not include a passive fixing plate and may include only a passive diaphragm 131a. In addition, in contrast to what is shown in the drawing, the passive diaphragm 131a may include a plurality of circular protrusions and a plurality of circular grooves so as to have an appearance similar to the speaker 110.

A display apparatus according to an embodiment may include a display panel, a rear cover configured to cover a rear surface of the display panel and having an opening, and a speaker arranged between the display panel and the rear cover, the speaker comprising a diaphragm exposed to a rear side of the rear cover through the opening, and a fixing plate inserted into a through-hole formed in a center of the diaphragm. The fixing plate may be configured so as not to vibrate together with the diaphragm.

The speaker may include a magnet.

The speaker may further include a first plate configured to cover a first surface of the magnet.

The speaker may further include a second plate configured to cover a second surface opposite to the first surface, and a support member arranged between the first plate and the fixing plate to support the fixing plate.

The fixing plate may be configured to be coupled to the support member.

By coupling the fixing plate to the support member, a position of the fixing plate may be fixed.

The support member may include a guide portion protruding toward the fixing plate to guide a coupling position of the fixing plate.

The fixing plate may include a guide groove into which the guide portion is inserted.

The speaker may further include a ring magnet having a ring shape and configured such that the magnet is disposed at a center thereof.

The speaker may further include a ring plate having a ring shape and configured such that the first plate is disposed at a center thereof.

The speaker may further include a voice coil configured to be disposed in a receiving space formed between the magnet and the first plate, and the ring magnet and the ring plate.

The second plate may include a receiving groove corresponding to the receiving space to expand the receiving space.

The speaker may further include a connector configured to connect the voice coil and the diaphragm such that the diaphragm vibrates together with the voice coil.

The speaker may further include a frame configured to support the magnet such that the magnet is fixed.

The speaker may further include a first edge configured to connect an outer edge of the connector and the frame such that the frame supports the connector.

An inner edge of the connector may be connected to the voice coil.

The speaker may further include a second edge configured to connect an inner edge of the diaphragm and the fixing plate such that the fixing plate supports the inner edge of the diaphragm forming the through-hole.

An inner edge of the second edge may be connected to the fixing plate.

An outer edge of the second edge may be connected to the inner edge of the diaphragm.

The inner edge of the diaphragm may be supported by the fixing plate through the second edge.

An outer edge of the diaphragm may be supported by the frame through the first edge.

The diaphragm may be configured to vibrate between a first position located rearward of the fixing plate and a second position located forward of the fixing plate.

The fixing plate, the support member, the first plate, the magnet, and the second plate may be coupled by being adhered to each other.

The display apparatus may further include a first enclosure configured to support one side of the speaker.

The display apparatus may further include a second enclosure configured to support the other side of the speaker and configured to be coupled to the first enclosure.

The display apparatus may further include a passive radiator coupled to the first enclosure, the passive radiator including a passive diaphragm and a passive fixing plate inserted into a hole formed in a center of the passive diaphragm.

According to the spirit of the present disclosure, the speaker capable of providing excellent sound performance while reducing thickness, and the display apparatus including the same may be provided.

According to the spirit of the present disclosure, by dividing the diaphragm into the central portion and the outer portion, fixing the position of the central portion, and vibrating only the outer portion, the speaker with additionally secured internal space and the display apparatus including the same may be provided.

While the present disclosure has been particularly described with reference to exemplary embodiments, it should be understood by those of skilled in the art that various changes in form and details may be made without departing from the spirit and scope of the present disclosure.

1. A display apparatus comprising:
a display panel having a front surface and a rear surface;
a rear cover having a front side, a rear side, and an opening extending between the front side and the rear side, wherein the front side faces the rear surface of the display panel so that the rear cover covers the rear surface of the display panel; and
a speaker between the rear surface of the display panel and the front side of the rear cover, the speaker including
a diaphragm exposed to outside of the display apparatus through the opening of the rear cover, the diaphragm configured to vibrate and having a through-hole formed in a center of the diaphragm, and
a fixing plate in the through-hole of the diaphragm and fixed in position so as not to vibrate together with the diaphragm.

2. The display apparatus of claim 1, wherein the speaker further includes:
a magnet,
a first plate covering a first surface of the magnet,
a second plate covering a second surface of the magnet opposite to the first surface of the magnet, and
a support member arranged between the first plate and the fixing plate to support the fixing plate.

3. The display apparatus of claim 2, wherein
the fixing plate is coupled to the support member so that the fixing plate is thereby fixed in position.

4. The display apparatus of claim 2, wherein
the support member includes a guide portion protruding toward the fixing plate to guide a coupling position of the fixing plate.

5. The display apparatus of claim 4, wherein
the fixing plate includes a guide groove into which the guide portion is inserted.

6. The display apparatus of claim 2, wherein
the magnet is a center magnet, and
the speaker further includes:
a ring magnet having a ring shape with the center magnet in a center of the ring magnet,
a ring plate having a ring shape with the first plate in a center of the ring plate, and
a voice coil in a receiving space formed between the center magnet and the first plate, and the ring magnet and the ring plate.

7. The display apparatus of claim 6, wherein
the second plate includes a receiving groove corresponding to the receiving space to expand the receiving space.

8. The display apparatus of claim 6, wherein the speaker further includes:
a connector connecting the voice coil and the diaphragm such that the diaphragm vibrates together with the voice coil, and
a frame to support the ring magnet such that the ring magnet is fixed in position.

9. The display apparatus of claim 8, wherein
the speaker further includes a first edge connected to an outer edge of the connector and to the frame such that the frame supports the connector, and
an inner edge of the connector is connected to the voice coil.

10. The display apparatus of claim 9, wherein
the speaker further includes a second edge connecting an inner edge of the diaphragm and the fixing plate such that the fixing plate supports the inner edge of the diaphragm forming the through-hole.

11. The display apparatus of claim 10, wherein
an inner edge of the second edge is connected to the fixing plate, and
an outer edge of the second edge is connected to the inner edge of the diaphragm.

12. The display apparatus of claim 11, wherein
the inner edge of the diaphragm is supported by the fixing plate through the second edge, and
an outer edge of the diaphragm is supported by the frame through the first edge.

13. The display apparatus of claim 1, wherein
the diaphragm is configured to vibrate between a first position located rearward of the fixing plate and a second position located forward of the fixing plate.

14. The display apparatus of claim 2, wherein
the fixing plate is adhered to the support member,
the support member is adhered to the first plate,
the first plate is adhered to the magnet,
the magnet is adhered to the second plate, and
the fixing plate, the support member, the first plate, the magnet, and the second plate are thereby coupled together.

15. The display apparatus of claim 1, further comprising:
a first enclosure configured to support one side of the speaker,
a second enclosure configured to support another side of the speaker and configured to be coupled to the first enclosure, and
a passive radiator coupled to the first enclosure, the passive radiator including a passive diaphragm and a passive fixing plate inserted into a hole formed in a center of the passive diaphragm.
